(19) United States
(12) Patent Application Publication
(10) Pub. No.: US 2003/0025276 A1
(43) Pub. Date: Feb. 6, 2003

(54) Shaft sealing devices, compressors comprising the shaft sealing devices, and methods for sealing a rotational shaft

(76) Inventors: Takayuki Kato, Kariya-shi (JP); Hiroaki Kayukawa, Kariya-shi (JP); Tetsuhiko Fukanuma, Kariya-shi (JP); Hiroshi Kubo, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/202,116

(22) Filed: Jul. 23, 2002

(30) Foreign Application Priority Data
Jul. 23, 2001 (JP) 2001-222109

(51) Int. Cl. F16J 15/32

(52) U.S. Cl. 277/549

(57) ABSTRACT

A shaft sealing device 50 may comprise a first lip 51 and a second lip 55 that contact a circumferential surface 8a of a drive shaft 8. The first lip 51 may include a movable portion (bendable portion) 53 that extends from a fixed portion 52. A plurality of concave portions (recesses) 54 may be defined around the outer circumferential surface of the movable portion 53. Thin portions 59a are defined corresponding to the concave portions 54. Thick portions 59b are defined adjacent to the thin portions 59a and are preferably thicker than the thin portions 59a. Because of the effect of concave portions 54, the stress of the first lip 51 is reduced when the shaft sealing device 50 is disposed around the drive shaft 8. In addition, because the thin portions 59a and thick portions 59b are intermittently disposed in the circumferential direction on the first lip 51, the pressure of the refrigerant gas within the crank chamber 9 acts upon the space 58.

### BACKGROUND OF THE INVENTION

1. Field of the Invention

The present invention relates to shaft sealing drives that may be used, e.g., to provide a seal between a compressor drive shaft and a compressor housing. The present invention also relates to methods for sealing a drive shaft.

2. Description of the Related Art

Known compressors include a housing, a drive shaft that drives the compression mechanism and a shaft sealing device that seals the surface of the drive shaft. The shaft sealing device is disposed between the drive shaft and the housing. The shaft sealing device comprises a lip member that is made of rubber or a resin. The lip member contacts and seals the surface of the drive shaft when high pressure refrigerant acts on the lip member. The lip member must be resistant to heat and abrasion due to the environment in which is used. In order to improve resistance to heat and abrasion, it is effective to reduce the lip member's interference, which is defined as the displacement between a position before the lip member is set and a position after the lip member has been set. However, it is preferable to maintain the lip member's interference in order to maintain its ability to seal, because changing the lip member's interference is apt to affect maintaining the ability to seal that is main object of the lip member.

A prior art lip member comprising a concave ring is disclosed in Japanese Laid-open Utility Model Publication S63-109076. The concave ring reduces the stress with respect to the drive shaft, and has the ability to suppress abrasion and heat generated between the concave ring and the drive shaft. However, when this lip member is utilized in a conventional compressor, compressed fluid acts upon the lip member and the lip member is compressed toward the surface of the drive shaft. Because the concave ring is a thin-walled portion of the lip member, the concave ring will deform due to low rigidity. In addition, the area of contact between the lip member and the drive shaft increases. Thus, although prior art lip member can reduces the stress of the lip member, there are limitations on the suppression of abrasion and heat generated between the lip member and the drive shaft.

### SUMMARY OF THE INVENTION

It is, therefore, one object of the present teachings to provide improved shaft sealing technology that can reduce the stress with respect to a rotational shaft disposed in machines such as compressors and the deformation of a lip member that contacts the surface of the rotational shaft.

In one aspect of the present teachings, shaft sealing devices are taught that comprise a lip member that contacts the surface of a rotational shaft (e.g., drive shaft of a compressor). The lip member may be formed from an elastic material, such as rubber or resin. The lip member preferably seals the surface of the rotational shaft, and prevents refrigerant gas and lubricating oil from leaking between the lip member and the rotational shaft.

In one embodiment of the present teachings, the lip member may comprise thin portions and thick portions that have different relative thickness. Concave and convex shapes are preferably defined on the surface of the lip member. In the alternative, hollow portions may be defined within the interior of the lip member. By providing thin portions within the lip member, the stress of the lip member with respect to the rotational shaft can be reduced without reducing the interference of the lip member. Again, interference is defined as the displacement between a position before the lip member is set and a position after the lip member has set. The thin portions and the thick portions of the lip member of the present teachings are intermittently (alternately) formed around the circumferential direction of the lip member.

The term “intermittently” is intended to broadly include thin portions and the thick portions that are discontinuously disposed, i.e., a situation in which the thin portions and the thick portions are intermittently disposed. For example, the thickness between the thin portions and the thick portions may gradually change or may change in discrete steps. The term “circumferential direction” is intended to broadly cover the circumferential direction of the lip member and the circumferential direction of the rotational shaft. In many situations, the circumferential direction of the lip member and the circumferential direction of the rotational shaft are the same. However, the criteria for the term “circumferential direction” in the present invention also includes situations in which these circumferential directions are slightly different from one and another.

The thin portions preferably reduce the stress on the lip member. Further, the thick portions permit the lip member to maintain rigidity. Thus, the stress of the lip member can be reduced while also suppressing deformation of the lip member. When outside pressure acts upon the lip member, it is possible to prevent deformation of the lip member and an increase of the surface area thereof in contact with the rotational shaft due to the rigidity of the thick portions.

The lip member of the present teachings is not limited to requiring thin portions and thick portions that are provided in the circumferential direction of the lip member. However, lip members of the present teachings are preferably defined to include means for increasing the rigidity of the lip member, which in turn suppresses the extreme deformation thereof even when pressure is applied thereto. According to the present teachings, an efficient shaft sealing device that reduces the stress of the lip member with respect to the rotational shaft, and which can suppresses the deformation of the lip member, can be realized.

In one particularly preferred embodiment, the thin portions of the present invention can be realized by forming concave portions within the lip member. For example, a plurality of concave portions may be formed in the outer peripheral surface of a lip member having an approximately uniform thickness. The concave portions will thus define the thin portions, while the thick portions are all other parts on the lip member. In this way, a lip member can be realized in which the structure of the lip member is simple and simple to manufacture.

In addition, the edge of the lip member is preferably thicker than the part of the thin portions. In this way, for example, it is more effective to suppress the deformation of the lip member than compared to the case that the thin portions are formed with the same thickness up to the edge of the lip.

In another embodiment of the present teachings, the shaft sealing device may be disposed around a drive shaft for driving a compression mechanism of a compressor. For example, the shaft sealing device may be disposed between the drive shaft and a housing that rotatably supports the drive shaft. The lip member of the shaft sealing device preferably contacts the circumferential surface of the drive shaft and seals the circumferential surface of the drive shaft. When pressurized (compressed) refrigerant gas within the housing acts upon the lip member, the lip member is pressed toward the circumferential direction of the drive shaft.

Because the lip member includes thin portions intermittently formed with thick portions, the stress on the lip member is reduced by means of the thin portions and the rigidity of the lip member can be maintained by means of the thick portions. Therefore, the stress of the lip member is reduced while also suppressing deformation of the lip member. Thus, even if the pressure of the refrigerant gas acts upon the lip member, the deformation of the lip member and the increase in the surface area in contact with the drive shaft can be prevented by means of the rigidity of the thick portions. The present teachings are particularly effective for shaft sealing devices of compressors in which outside pressure acts upon the lip member.

In addition, in another preferred embodiment, compressors may include a drive shaft that is coupled directly to an outside drive source, i.e., a clutchless structure. That is, the drive shaft of the clutchless structure is coupled directly to the outside drive source, e.g., a vehicle engine, and not via a clutch mechanism. In this case, the drive shaft will rotate when the compressor is operating, as well as when the vehicle engine is idling. By utilizing the present shaft sealing devices in clutchless compressors, power loss between the drive shaft and the lip member can be reduced or minimized. Thus, the present teachings are particularly effective in shaft sealing devices of clutchless compressors in which the drive shaft rotates even though the outside drive source is idling.

In another aspect of the present teachings, methods for sealing a rotational shaft are taught that may include using a lip member that comprises thin portions and thick portions that have different relative thickness and which are intermittently formed around the circumferential direction of the lip member. According the present methods, stress on the lip member with respect to a rotational shaft is reduced and deformation of the lip member can be suppressed. Thus, even if pressure acts upon the lip member, the deformation of the lip member and the increase in the surface area in contact with the rotational shaft can be prevented by means of the rigidity of the thick portions. The present methods can be advantageously utilized in compressors that are constructed such that outside pressure acts upon the lip member.

### BRIEF DESCRIPTION OF THE DRAWINGS

FIG. 1 is a vertical cross-sectional view of a representative variable displacement compressor 100;

FIG. 2 is a partial enlargement of FIG. 1;

FIG. 3 is a cross-sectional view taken along line A-A of FIG. 2;

FIG. 4 is a cross-sectional view of a first lip 151, which is a modification of the first lip 51 of the representative variable displacement compressor 100;

FIG. 5 is a cross-sectional view of a first lip 251, which is another modification of the first lip 51 of the representative variable displacement compressor 100; and

FIG. 6 is a cross-sectional view of a first lip 351, which is another modification of the first lip 51 of the representative variable displacement compressor 100.

### DETAILED DESCRIPTION OF THE INVENTION

In another embodiment of the present teachings, shaft sealing devices may include a lip member arranged and constructed to contact and seal a circumferential surface of a drive shaft. Preferably, the lip member includes thin portions and thick portions that have different relative thickness and are alternately defined around the circumferential surface of the lip member. The thin portions may include concave portions defined within the lip member.

The concave portions may be defined on an outer circumferential surface of the lip member or on an inner circumferential surface of the lip member. Further, the concave portions may include hollow portions defined on an inner circumferential surface of the lip member. In addition, an edge of the lip member may be thicker than the thin portions.

In another embodiment of the present teachings, compressors are taught that include the above-described shaft sealing devices. In this embodiment, the rotational shaft comprises a drive shaft for driving a compression mechanism of a compressor. Thus, the shaft sealing devices may be interleaved or interposed between the drive shaft and a portion of the compressor housing that rotatably supports the drive shaft. Further, the drive shaft may be coupled directly to an outside drive source, e.g., a vehicle engine, without a clutch interleaved therebetween.

In another embodiment of the present teachings, methods are taught for sealing a rotational shaft. Such methods may include contacting an outer circumferential surface of the rotational shaft with a lip member that comprises thin portions and thick portions that have different relative thickness. In this case, the outer circumferential surface of the rotational shaft may be sealed.

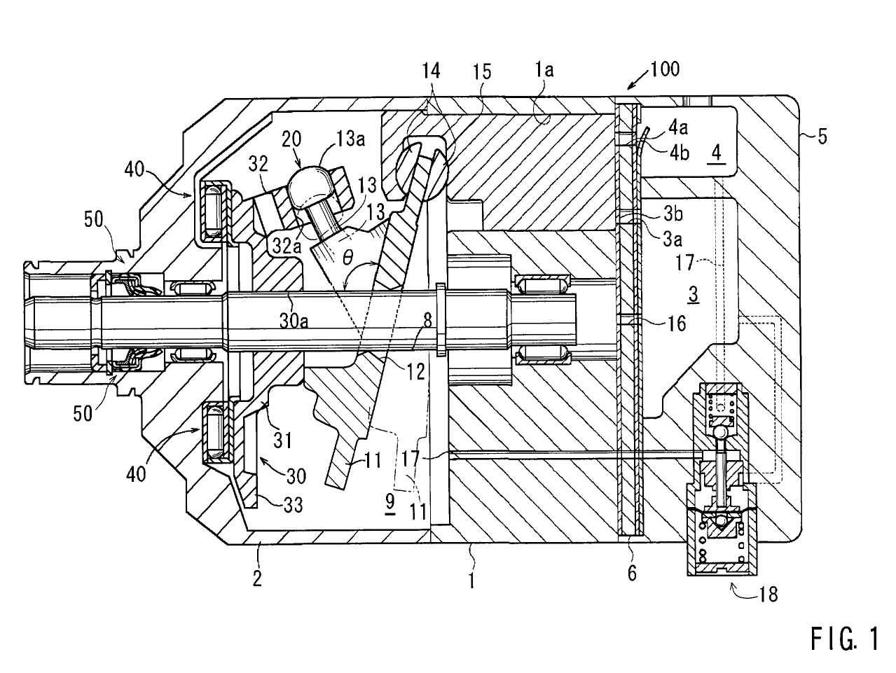

A representative variable displacement compressor 100 (hereinafter referred to as a “compressor 100”) of the present teachings will now described in further detail with reference to the drawings. Referring to FIG. 1, the compressor 100 may comprise a cylinder block 1, a front housing 2, and a rear housing 5. The front housing 2 may be joined to the front side (left end as viewed in FIG. 1) of the cylinder block 1. The rear housing 5 may be joined to the rear side (right end as viewed in FIG. 1) of the cylinder block 1 via a valve plate 6.

A suction chamber 3 may be defined within the rear housing 5 for drawing in refrigerant gas. A discharge chamber 4 also may be defined within the rear housing 5 for discharging compressed refrigerant gas. The valve plate 6 may comprise a suction port 3a and a discharge port 4a. The suction port 3a may connect the suction chamber 3 to a cylinder bore 1a via a suction valve 3b. The discharge port 4a may connect the discharge chamber 4 to the cylinder bore 1a via a discharge valve 4b. The valve plate 6 may comprise a bleed gas port 16 that permits a crank chamber 9 defined within the front housing 2 to communicate with the suction chamber 3.

A drive shaft 8 (rotational shaft) may extend through the cylinder block 1 and the front housing 2. The drive shaft 8 may be directly coupled to an outside drive source, e.g., a vehicle engine (not shown in the FIG. 1). A clutch mechanism, e.g., an electromagnetic clutch, is not required in this embodiment. The drive shaft 8 is rotatably driven by the vehicle engine, and drives a compressor mechanism that may comprise a piston 15 and other parts described below. The rear portion of the drive shaft 8 may be rotatably supported by the cylinder block 1 and the front portion of the drive shaft 8 may be rotatably supported by the front housing 2.

A disk-shaped swash plate 11 may be disposed within the crank chamber 9. The swash plate 11 is slidably fitted onto the drive shaft 8 via an insertion hole 12 that is defined within the central portion of the swash plate 11. A pin 13 having a rounded portion 13a on one end thereof may be disposed at two points on the swash plate 11 opposite the cylinder block 1. A rotor 30 may be joined to the drive shaft 8 and may rotate integrally with the drive shaft 8. The rotor 30 may comprise a rounded base portion 31 that includes a support arm 32 and a counterweight 33. The base portion 31 also may comprise an insertion hole 30a and the drive shaft 8 may be inserted into the insertion hole 30a.

The rotor 30 may be connected to the swash plate 11 via a hinge mechanism 20. The hinge mechanism 20 may comprise an engagement structure that engages the support arm 32 and the pin 13. The support arm 32 may include a support hole 32a that corresponds to the rounded portion 13a on the pin 13. The rounded portion 13a of the pin 13 is inserted into the support hole 32a and the support arm 32 supports the pin 13. The pin 13 is capable of sliding within the support hole 32a. The hinge mechanism 20 transmits the rotational torque of the drive shaft 8 to the swash plate 11 when the swash plate 11 engages the support arm 32 and the pin 13. The hinge mechanism 20 is capable of tilting the swash plate 11. Thus, the swash plate 11 is capable of sliding and tilting with respect to the drive shaft 8.

A plurality of cylinder bores 1a may be defined within the cylinder block 1 and may be positioned at predetermined intervals around a rotational axis of the drive shaft 8. A piston 15 may be slidably received within each cylinder bore 1a. The front end of the piston 15 may be connected to the peripheral portion of the swash plate 11 via a pair of shoes 14. The swash plate 11 rotates together with the rotation of the drive shaft 8. Further, the rotation of the swash plate 11 may be transmitted to each piston 15 as reciprocating movement along the axis direction of the corresponding cylinder bore 1a. When the piston 15 reciprocates, refrigerant gas is drawn or suctioned into the cylinder bore 1a and compressed refrigerant gas is discharged from the cylinder bore 1a.

A thrust bearing 40 may be interposed or interleaved between the rotor 30 and the front housing 2. Further, the thrust bearing 40 may contact the front surface of the base portion 31. Therefore, when a reaction force is applied to the piston 15 during compressor operation, which force is caused by the reciprocating movement of the piston 15, the front housing 2 may receive this reaction force via the shoes 14, the swash plate 11, the hinge mechanism 20 and the thrust bearing 40.

The displacement of the compressor 100 is determined by the stroke length of the piston 15 (i.e., the distance from the pistons' top dead center to bottom dead center). The stroke length of the piston 15 is determined by inclination angle θ of the swash plate 11. When the inclination angle θ of the swash plate 11 with respect to the axis of the drive shaft 8 increases, the stroke length of the piston 15 and the displacement also increase. When the inclination angle θ of the swash plate 11 with respect to the axis of the drive shaft 8 decreases, the stroke length of the piston 15 and the displacement also decrease. The inclination angle θ of the swash plate 11 is determined by the difference between the pressures within the cylinder bores 1a and the crank chamber 9. This pressure differential may be adjusted by a displacement control valve 18. As shown in FIG. 1, the inclination angle θ of the swash plate 11 is shown at its maximum, i.e., the state in which the displacement is at a maximum. When the displacement is at a minimum, the swash plate 11 may be in the position shown by the dotted line in FIG. 1.

The displacement control valve 18 extends between the cylinder block 1 and the rear housing 5 and is disposed within a gas supply channel 17 that may permit the discharge chamber 4 to communicate with the crank chamber 9. The displacement control valve 18 may preferably be an electromagnetic valve and may control the size of the aperture of the gas supply channel 17. When the size of the aperture of the gas supply channel 17 is changed, the pressure within the crank chamber 9 will vary or change. Thus, the difference between the pressure within the cylinder bores 1a and the pressure within the crank chamber 9 may be controlled. As a result, the inclination angle θ of the swash plate 11 with respect to the drive shaft 8 can be varied to effect a change in the stroke length of the piston 15. Consequently, the displacement of refrigerant gas can be adjusted during operation of the compressor.

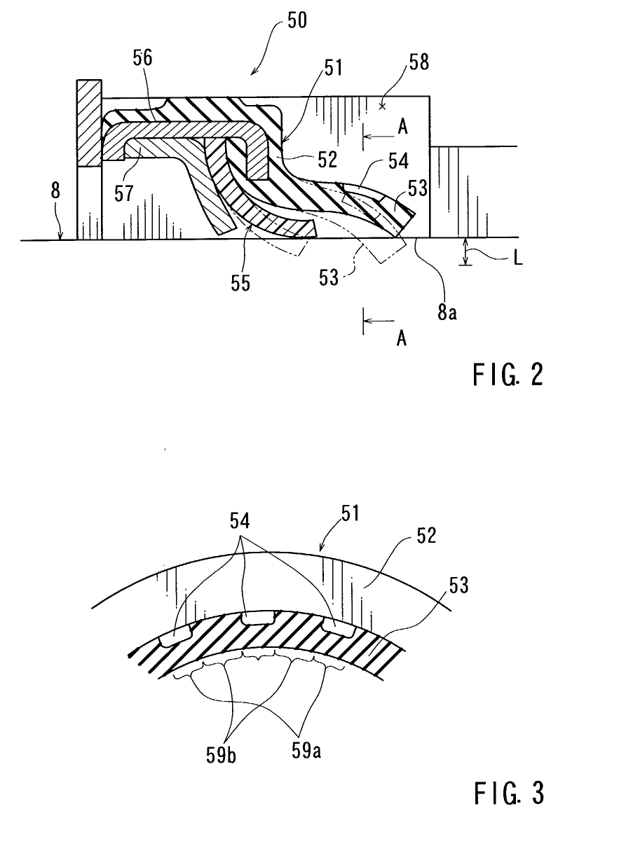

As shown more clearly in FIG. 2, a shaft sealing device 50 may comprise a first lip 51, a second lip 55 and metal holders 56, 57. The first lip 51 and the second lip 55 contact the circumferential surface 8a of the drive shaft 8. The first lip 51 (lip member) may be made of rubber or another elastic material. The second lip 55 may be made of a resin or another elastic material. The second lip 55 preferably is disposed between the first lip 51 and the metal holder 57. The metal holders 56, 57 may be made of any type of metal. The metal holder 56 retains the first lip 51 and the metal holder 57 retains the second lip 55. A space 58 is defined along the outer circumference of the first lip 51 and may communicate with the crank chamber 9. When refrigerant gas within the crank chamber 9 flows into the space 58, the pressure of the refrigerant gas acts upon the outer circumference of the first lip 51.

In the state shown by the dotted lines in FIG. 2, the first lip 51 and the second lip 55 are in a no-load state before being set around the drive shaft 8. When the shaft sealing device 50 is set around the drive shaft 8, the circumferential surface 8a of the drive shaft 8 may press the first lip 51 and the second lip 52. In that case, the first lip 51 and the second lip will be in the state shown by the solid lines in FIG. 2. In this state, the stress of the first lip 51 and the second lip 55 acts upon the circumferential surface 8a of the drive shaft 8. This stress provides a seal that seals the interior and exterior of the housing. In this way, refrigerant gas within the crank chamber 9 is prevented from leaking out along the circumferential surface 8a of the drive shaft 8 to the exterior of the housing. The amount of displacement L of the first lip 51 at this time is the interference of the first lip 51, which interference is defined as the displacement between a position before the lip member is set and a position after the lip member has set.

The first lip 51 may include a movable portion (bendable portion) 53 that extends from a fixed portion 52. A plurality of concave portions (recesses) 54 may be defined around the outer circumferential surface of the movable portion 53. As shown in FIG. 3, the concave portions 54 are defined around the entire circumference in the circumferential direction at approximately equal intervals. The number, shape, intervals, etc., of the concave portions 54 can be modified according to need. Thin portions 59a are defined corresponding to the concave portions 54. Thick portions 59b are defined adjacent to the thin portions 59a and are preferably thicker than the thin portions 59a. The thin portions 59a and the thick portions 59b are alternately defined around the circumferential direction of the movable portion 53. The thickness of the first lip 51 gradually changes between the thin portions 59a and the thick portions 59b. In the present embodiment, the circumferential direction of the first lip 51 and the circumferential direction of the drive shaft 8 are the same. Thus, the embodiment includes thin portions and thick portions that are intermittently formed in the circumferential state. The edge of the movable portion 53 of the first lip 51 is thicker than the thin portions 59a of the concave portions 54.

In the present embodiment, because of the effect of concave portions 54, the stress of the first lip 51 is reduced when the shaft sealing device 50 is disposed around the drive shaft 8. In addition, because the thin portions 59a and thick portions 59b are intermittently disposed in the circumferential direction on the first lip 51, even if the first lip 51 is pressed by the pressure of the refrigerant gas within the space 58 towards the circumferential direction of the drive shaft 8, deformation of the movable portion 53 can be suppressed due to the rigidity of the thick portions 59b. In addition, an increase in the surface area that contacts the circumferential surface 8a of the drive shaft 8 can be avoided.

According to the present teachings, the stress of the first lip 51 with respect to the drive shaft 8 can be reduced without reducing the interference of the first lip 51, because the concave portions 54 (thin portions 59a) are provided on the first lip 51. Because both the thin portions 59a and the thick portions 59b are formed intermittently in the circumferential direction of the first lip 51, the stress of the first lip 51 can be reduced, and moreover, the deformation of the first lip 51 can be suppressed. In this way, even if the pressure of the refrigerant gas within the crank chamber 9 acts upon the first lip 51, the deformation of the first lip 51 and the increase in the surface area in contact with the drive shaft 8 can be prevented.

According to the present teachings, the structure of the first lip 51 is simple. Further, methods for manufacturing the first lip 51 are simplified due to inclusion of the concave portions 54 and the thin portions 59a.

According to the present teachings, because the edge of the first lip 51 is thicker than the thin portions 59a that are defined corresponding to the concave portions 54, it is more effective to suppress the deformation of the first lip 51 than compared to the thin portions 59a are formed with the same thickness up to the edge thereof.

The present teachings are not limited to the representative embodiment described above, but may be modified in various ways. For example, the aforementioned embodiment can be adapted to create the following additional embodiments.

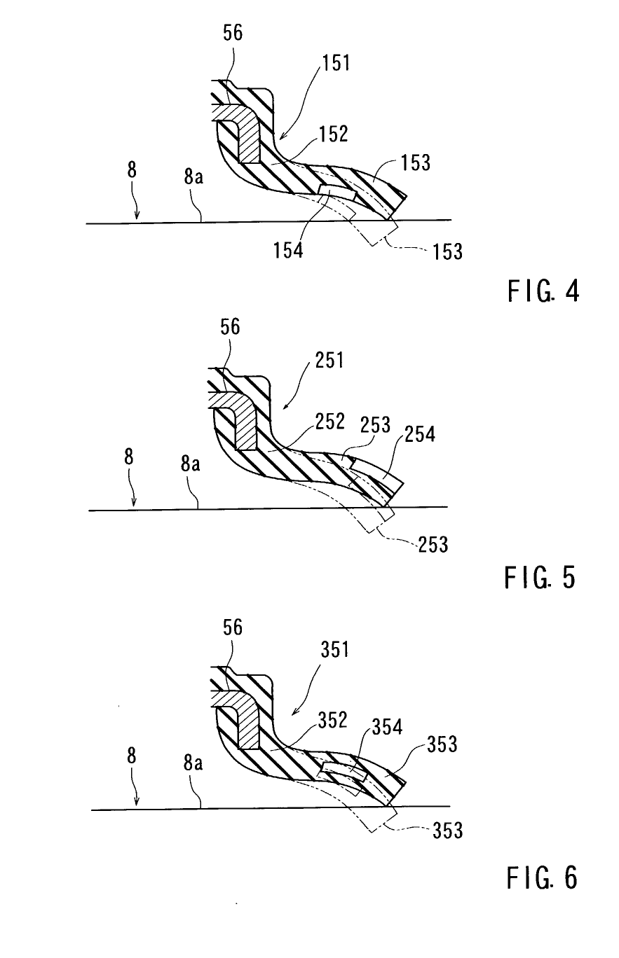

For example, in the representative embodiment, the concave portions 54 are defined around the outer circumference of the movable portion 53 of the first lip 51 and the thin portions are defined corresponding to the concave portions 54. However, the arrangement and construction of the thin portions 59a can be modified in a variety of ways according to need. This alternative embodiment may be, e.g., further modified as shown in FIGS. 4 to 6.

As shown in FIG. 4, a first lip 151 may include concave portions 154 defined around the inner circumferential surface of a movable portion 153 that extends from a fixed member 152. As shown in FIG. 5, a first lip 251 may include concave portions 254 defined around the edge of a movable portion 253 that extends from a fixed portion 252. The concave portions 254 extend up to and through the first lip 251. As shown in FIG. 6, a first lip 351 may include hollow portions 354 defined within a movable portion 353 that extends from a fixed portion 352. The concave portions 154, concave portions 254, and hollow portions 354 are preferably defined within the thin portions. Further, the thick portions preferably do not include the concave portions 154, concave portions 254, and hollow portions 354.

In addition, a plurality of combinations of the concave portions 54, the concave portions 154, the concave portions 254, and the hollow portions 354 are also possible.

In another modification of the representative embodiment, although the shaft sealing device 50 was described for a clutchless-type compressor 100, the present teachings can be adapted for shaft sealing devices of compressors having a clutch mechanism. Moreover, the present teachings can be adapted for shaft sealing devices in devices other than compressors.

1. A shaft sealing device, comprising:
a lip member arranged and constructed to contact and seal a circumferential surface of a rotational shaft, the lip member comprising thin portions and thick portions that have different relative thickness and are alternately defined around the circumferential surface of the lip member.

2. A shaft sealing device as in claim 1, wherein the thin portions comprise concave portions defined within the lip member.

3. A shaft sealing device as in claim 2, wherein the concave portions are defined on an outer circumferential surface of the lip member.

4. A shaft sealing device as in claim 2, wherein the concave portions are defined on an inner circumferential surface of the lip member.

5. A shaft sealing device as in claim 2, wherein the concave portions include hollow portions defined on an inner circumferential surface of the lip member.

6. A shaft sealing device as in claim 3, wherein an edge of the lip member is thicker than the thin portions.

7. A compressor comprising:
the shaft sealing device as in claim 1, wherein the rotational shaft comprises a drive shaft for driving a compression mechanism of a compressor.

8. A compressor as in claim 7, wherein the drive shaft is a clutchless structure, and is coupled directly to an outside drive source.
